(19) United States
(12) Patent Application Publication
(10) Pub. No.: US 2012/0223112 A1
(43) Pub. Date: Sep. 6, 2012

(54) GOLF BAG BUDDY SYSTEMS

(76) Inventor: Doug Campbell, Lindsay (CA)

(21) Appl. No.: 13/352,832

(22) Filed: Jan. 18, 2012

Related U.S. Application Data
(60) Provisional application No. 61/448,928, filed on Mar. 3, 2011.

(51) Int. Cl. B60R 9/00

(52) U.S. Cl. 224/274

(57) ABSTRACT

Golf bag buddy is a bracket (assembly) that is designed to attach a golf bag to a motorized golf cart. This product allows for easy access to the golf clubs, as well as the bag's pockets. The design is portable and allows users to move the device from cart to cart as needed. This device is designed to make any golf game or practice more enjoyable by making it easier for an individual to access their equipment.

### CROSS-REFERENCE TO RELATED APPLICATION

The present application is related to and claims priority from prior provisional application Ser. No. 61/448,928, filed Mar. 3, 2011 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. FIELD OF THE INVENTION

The present invention relates generally to the field of golf vehicle accessories and more specifically relates to a support attachment for retaining a golf bag to a rear portion of a golf vehicle.

### 2. DESCRIPTION OF THE RELATED ART

Many individuals in modern society play sports to maintain a healthy lifestyle. One of the more popular sports is golf. Golf is a precision club and ball sport, in which competing golfers use a variety of clubs to hit balls into a series of holes on a golf course using the fewest number of strokes. Some golfers carry their golf clubs about the course as the game is played. This can be a tiresome endeavor given courses can be nine or more holes, each hole comprising a considerable distance from the last. Other golfers use golf carts to transport the golfers and clubs between shots, possibly making the game progress at a quicker pace and making it more enjoyable. Golf carts may also make the game more accessible and viable for elderly players.

Currently, the way golf bags are strapped into the golf cart makes it difficult for players to remove their clubs and accessories from the bag(s). It can be hard to identify which club is which and many players end up removing several clubs before they find the correct one. The pockets at the rear of the bag are typically not easily accessible without undoing the retainer strap. This may be time consuming and inconvenient. Also, large golf bags may be damaged by the limited room provided in a golf cart.

Various attempts have been made to solve the above-mentioned problems such as those found in U.S. Pat. No. 4,355,746; U.S. Pub No. 2003/0097736; U.S. Pat. No. 7,600,729; U.S. Pub No. 2005/0000987; U.S. Pat. Nos. 6,227,427; and 4,768,650. This prior art is representative of brackets. None of the above inventions and patents, taken either singly or in combination, is seen to describe the invention as claimed.

Ideally, a support attachment for retaining a golf bag to a rear portion of a golf vehicle should be user-friendly and not damage the golf cart's resale value, yet would operate reliably and be manufactured at a modest expense. Thus, a need exists for a reliable golf bag support attachment system to avoid the above-mentioned problems.

### BRIEF SUMMARY OF THE INVENTION

In view of the foregoing disadvantages inherent in the known bracket art, the present invention provides a novel golf bag support attachment system. The general purpose of the present invention, which will be described subsequently in greater detail is to provide a convenient means for supporting golf bags on golf carts for easy access by golfers.

Golf bag buddy is a bracket that is designed to attach a golf bag to a motorized golf cart. This product allows for easy access to the golf clubs, as well as the bag's pockets. The design is portable and allows users to move the device from cart to cart as needed. This innovative apparatus is designed to make any golf game or practice more enjoyable by making it easier for an individual to access their equipment.

A support attachment for retaining a golf bag to a rear portion of a golf vehicle is disclosed herein in a preferred embodiment comprising: at least one bracket assembly comprising: at least one bracket support; at least one golf vehicle fastener; and at least one golf bag attacher, the golf bag attacher comprising a carabiner clip in preferred embodiments. The bracket support comprises a proximal end and a distal end; wherein the proximal end of the bracket support comprises a first support arm and a second support arm. The first and second support arms of the bracket support extend outwardly at about a 90 degree angle from the bracket support.

The first support arm and second support arm of the bracket support comprise substantially identical measurements and dimensions and are substantially parallel to each other. The distal end of the first and second support arms each comprise a round-shaped hole. The bracket support preferably comprises ferrous material which is durable in service and comprises a rust-proof coating providing enhanced weather-resistance for the support attachment.

The round-shaped hole(s) (round or substantially round) comprise a circumference substantially equivalent to a circumference of the golf vehicle fastener; the golf vehicle fastener able to pass through the round-shaped hole(s). The rear portion of the golf vehicle fits within a gap space located between the first support arm and the second support arm of the bracket support. The golf vehicle fastener is insertable through the round-shaped hole of the first support arm to frictionally retain the rear portion of the golf vehicle against the second support arm.

The golf bag attacher is preferably located on the distal end of the bracket support; wherein the golf bag attacher attaches the golf bag to the bracket support forming a user-defined angle of the golf bag from the rear portion of the golf vehicle (as it hangs therefrom) dependant on length of the golf bag attacher. The golf bag is secured to the golf vehicle via the golf bag attacher attached to the bracket support during transport about a golf course while providing improved ease of access to the golf bag(s) by a golfer.

A method of using a support attachment for retaining a golf bag to a golf vehicle is disclosed herein comprising the steps of: installing a support bracket to a rear portion of the golf vehicle (cart) via a golf vehicle fastener; attaching the golf bag to the support bracket via a golf bag attacher to create a user-defined angle conducive for accessing golf clubs; and accessing the golf clubs and golf related articles from the golf bag.

The present invention holds significant improvements and serves as a golf bag support attachment system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, golf bag support attachment system, constructed and operative according to the teachings of the present invention.

FIG. 1 shows a perspective view illustrating a golf bag support attachment system in an in-use condition according to an embodiment of the present invention.

FIG. 2 is a perspective view illustrating the golf bag support attachment system in an in-use condition attached to a golf bag according to an embodiment of the present invention of FIG. 1.

FIG. 3 is a perspective view illustrating a bracket support, a golf vehicle fastener, and golf bag attacher in combination forming a bracket assembly according to an embodiment of the present invention of FIG. 1.

FIG. 4A is a perspective view illustrating the bracket assembly as attached to a golf vehicle according to an embodiment of the present invention of FIG. 1.

FIG. 4B is a perspective view illustrating the bracket assembly as attached to the golf bag according to an embodiment of the present invention of FIG. 1.

FIG. 5 is a perspective view illustrating the bracket assembly as used to couple the golf bag to the golf vehicle such that a golfer is able to access clubs and accessories from a convenient angle according to an embodiment of the present invention of FIGS. 1 and 4B.

FIG. 6 is a flowchart illustrating a method of use for the golf bag support attachment system according to an embodiment of the present invention of FIGS. 1-5.

The various embodiments of the present invention will hereinafter be described in conjunction with the appended drawings, wherein like designations denote like elements.

### DETAILED DESCRIPTION

As discussed above, embodiments of the present invention relate to a bracket device and more particularly to a golf bag support attachment as used to improve the convenience and accessibility of items stored in golf bags coupled to golf carts.

Generally speaking, Golf Bag Buddy provides golfers with an effective method for attaching a golf bag to a golf cart. The invention is comprised of a bracket made from metal or plastic or other suitable material. The U-channel portion of the bracket slides over the rear frame of a golf cart where the retainer straps are attached and is pinned beneath the rear frame using a cotterless hitch pin. The (about) 14 inch long portion of the bracket then attaches to a golf bag using a carabiner clip or other suitable means of attachment. The size of the U-channel portion (gap space) can vary slightly depending on the make and model of golf cart. It will typically measure about 4 inches and the overall length of the bracket is about 14 inches; however other dimensions may be used if desired.

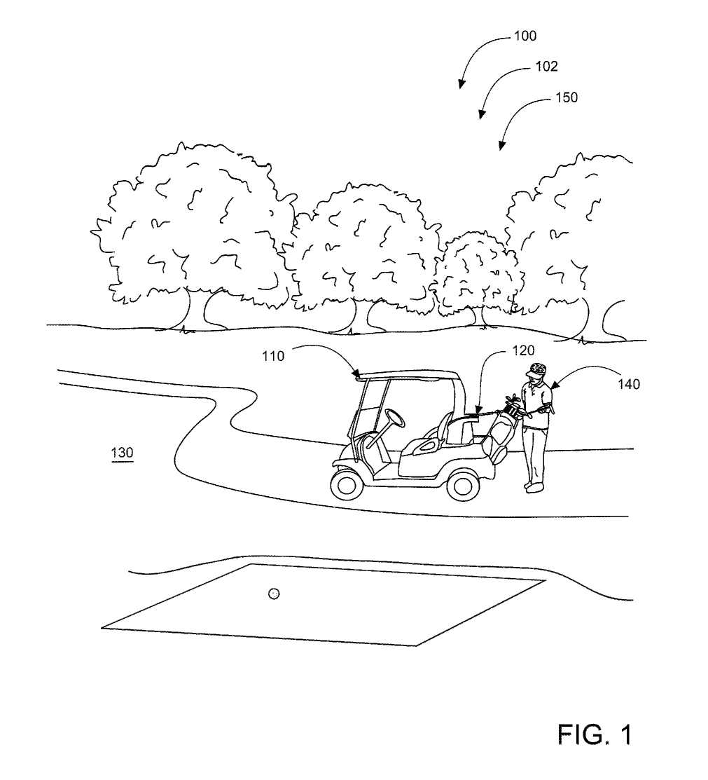

Referring to the drawings by numerals of reference there is shown in FIG. 1, a perspective view illustrating golf bag support attachment system 102 in an in-use condition 150 according to an embodiment of the present invention.

Golf bag support attachment system 102 (golf bag buddy systems 100) may comprise a support attachment for retaining golf bag 125 to a rear portion 200 of a golf vehicle 110 comprising: at least one bracket assembly 122. Bracket assembly 122 comprises: at least one bracket support 120; at least one golf vehicle fastener 160; and at least one golf bag attacher 170.

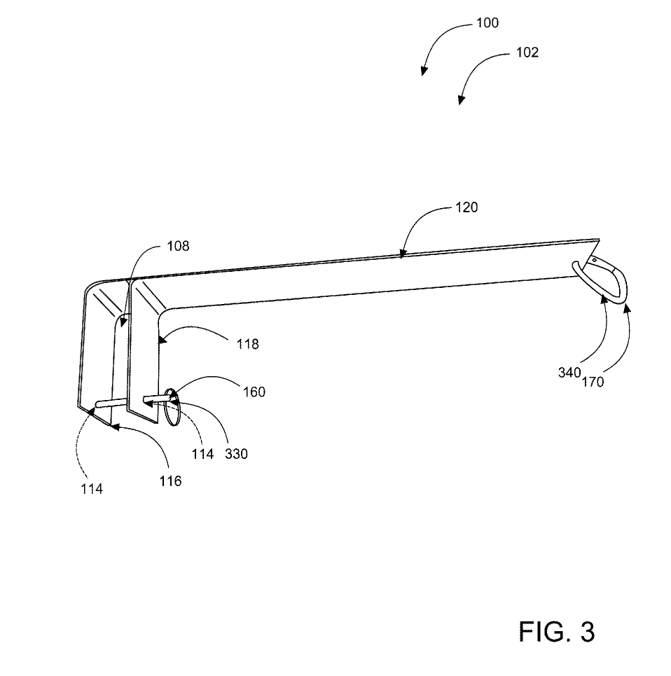

Bracket support 120 comprises a proximal end and a distal end; wherein the proximal end of bracket support 120 comprises first support arm 116 and second support arm 118. First support arm 116 and second support arm 118 of bracket support 120 extend outwardly at about a 90 degree angle from bracket support 120. First support arm 116 and second support arm 118 of bracket support 120 comprise substantially identical measurements and dimensions in preferred embodiments. First support arm 116 and second support arm 118 are substantially parallel to each other as shown in FIG. 3.

Further, to accommodate attachment to golf vehicle 110 first support arm 116 and second support arm 118 each comprise a round-shaped hole 114. Round-shaped hole(s) 114 comprise a circumference substantially equivalent to a circumference of golf vehicle fastener 160; golf vehicle fastener 160 able to pass through round-shaped hole(s) 114, as also shown in FIG. 3.

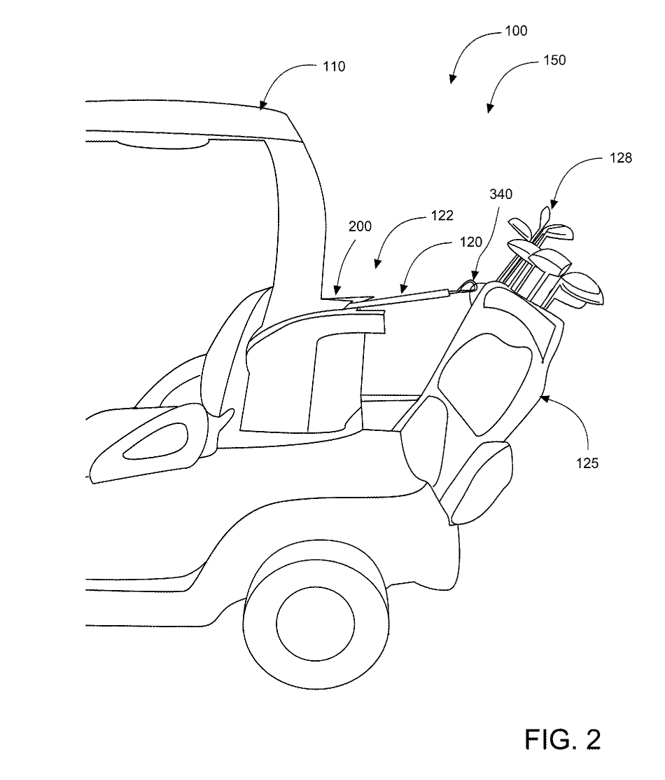

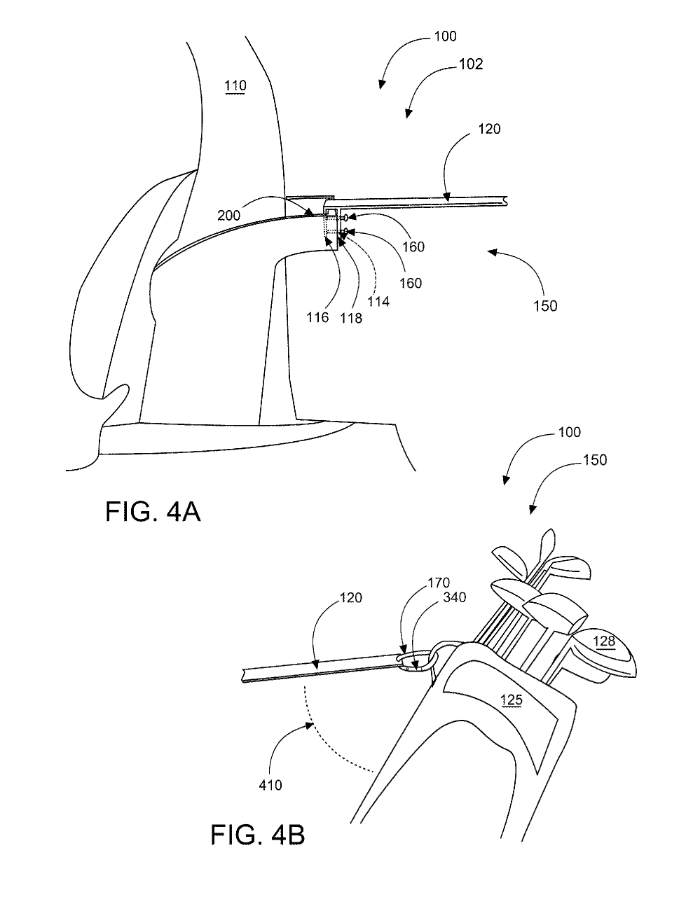

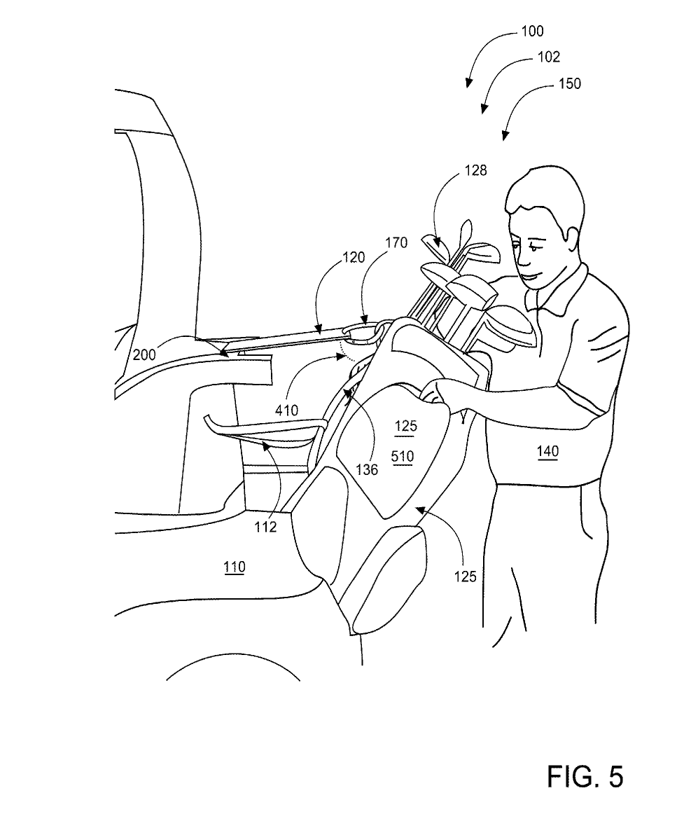

Rear portion 200 (back of seat or portion of body or frame) of golf vehicle 110 fits within a gap space 108 (U-channel portion) located between first support arm 116 and second support arm 118 of said bracket support, as shown in FIG. 4A. In this way the present invention may be fit to or retro-fitted to golf vehicle 110 without damaging golf vehicle 110 for resale. As mentioned, the present invention can be used with different models of golf vehicle(s) 110. Golf vehicle fastener 160 is insertable through round-shaped hole 114 of first support arm 116 to frictionally retain the rear portion 200 of golf vehicle 110 against second support arm 118. Golf bag attacher 170 is preferably located on the distal end of bracket support 120 (as also shown in FIG. 2); and golf bag 125 is thereby secured to golf vehicle 110 via golf bag attacher 170 attached to bracket support 120 during transport about a golf course 130 while providing improved ease of access to golf bag 125 by golfer 140, as shown in FIG. 5.

Referring now to FIG. 2, a perspective view illustrating golf bag support attachment system 102 in an in-use condition 150 attached to golf bag 125 according to an embodiment of the present invention of FIG. 1.

Golf bag attacher 170 attaches golf bag 125 to bracket support 120 forming a user-defined angle 410 (also alluded to in FIGS. 4B and 5) of golf bag 125 from rear portion 200 of golf vehicle 110 dependant on length of golf bag attacher(s) 170. Golf vehicle 110 comprises a golf cart such as made by Club Car®; Yamaha® and the like (slightly different dimensioning of bracket support 120 for example of gap space 108 may apply as needed.) Golf bag attacher(s) 170 may also be chained together for increased length if desired to increase angle of golf bag 125 from golf vehicle 110.

Referring now to FIG. 3, a perspective view illustrating bracket support 120, golf vehicle fastener 160, and golf bag attacher 170 in combination forming bracket assembly 122 according to an embodiment of the present invention of FIG. 1.

Bracket support 120 comprises ferrous material such as steel in preferred embodiments, given its inherent durability and cost-efficiency in manufacture. In these embodiments bracket support 120 comprises a rust-proof coating providing enhanced weather-resistance of the support attachment. In other alternate embodiments bracket support 120 comprises plastic or other such suitable equivalent materials. Golf vehicle fastener 160 comprises non-threaded fastener 330 in preferred embodiments for ease of removal and attachment. Non-threaded fastener 330 preferably comprises a pin and key fastener for securing bracket support 120 to rear portion 200 of golf vehicle 110. Non-threaded fastener 330 may comprise a recessed ball and a ring-pull in other embodiments, wherein the recessed ball is pushable in and out to release and lock non-threaded fastener 330. A cotterless hitch pin may also be used or other suitable equivalent(s).

Referring now to FIG. 4A, a perspective view illustrating bracket assembly 122 as attached to golf vehicle 110 according to an embodiment of the present invention of FIG. 1.

Golf vehicle fastener 160 may comprise a thumb screw for securing bracket support 120 to the rear portion 200 of golf vehicle 110. FIG. 4B, shows a perspective view illustrating bracket assembly 122 as attached to golf bag 125 according to an embodiment of the present invention of FIG. 1. The indicated user-defined angle 410 enables a golfer 140 to conveniently remove and insert at least one golf club 128 from golf bag 125; golf club 128 also oriented on the user-defined angle 410 within golf bag 125, as also shown in FIG. 5. Golf bag attacher 170 may comprise a sturdy-clip and/or a support ring. Sturdy-clip comprises a carabiner clip 340 in preferred embodiments such that golf bag 125 is easily removable. Carabiner clip 340 may also be attached to existing golf bag strap 136 on golf bag 125.

Golf bag support attachment system 102 (golf bag buddy systems 100) may be sold as kit 440 comprising the following parts: at least one bracket support 120; at least one golf vehicle fastener 160; at least one golf bag attacher 170; and at least one set of user instructions. Golf bag support attachment system 102 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different fastener/retaining means and combinations thereof, parts may be sold separately, etc., may be sufficient.

Referring now to FIG. 5, a perspective view illustrating bracket assembly 122 as used to couple golf bag 125 to golf vehicle 110 such that a golfer 140 is able to access golf club 128 and accessories from a convenient angle according to an embodiment of the present invention of FIGS. 1 and 4B.

Bracket support 120 is couplable with at least one existing securing strap on golf bag 125 belonging to golfer 140. In this way bracket support 120 provides a redundant securer of golf bag 125 in addition to (existing) retainer belt 112 of golf bag 125 on golf vehicle 110. Bracket support 120 in combination with existing golf bag retaining belt (retainer belt 112) allow golf bag 125 to be positioned at a hang-sit angle of greater than 20 degrees relative to a vertical position of the rear portion 200 of golf vehicle 110, creating user-defined angle 410 as also shown in FIGS. 2 and 4B. A plurality of compartments 510 in golf bag 125 are thereby more accessible to golfer 140 via user-defined angle 410 provided by bracket support 120.

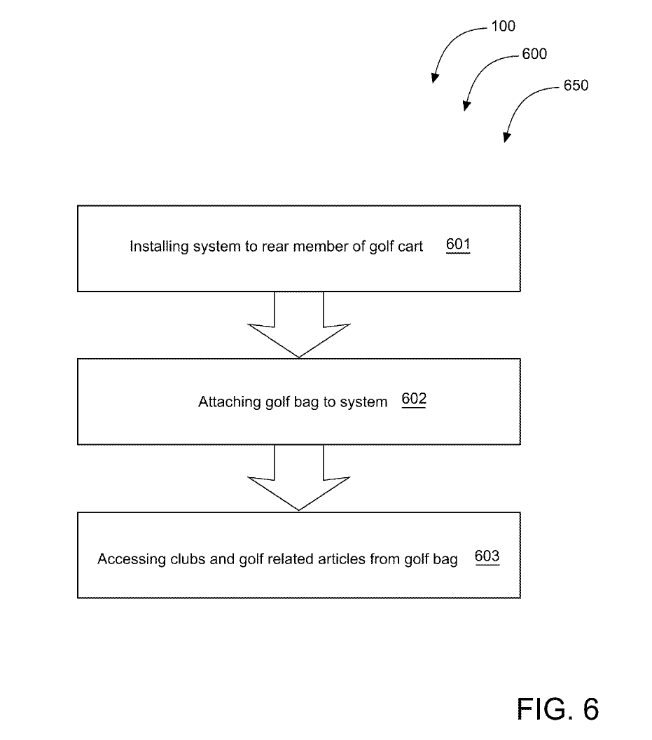

FIG. 6 is a flowchart 650 illustrating a method of use 600 for golf bag support attachment system 102 according to an embodiment of the present invention of FIGS. 1-5.

A method of using (method of use 600) a support attachment for retaining at least one golf bag 125 to golf vehicle 110 comprises the steps of: step one 601 installing support bracket 120 to rear portion 200 of golf vehicle 110 via golf vehicle fastener 160; step two 602 attaching golf bag 125 to support bracket 120 via golf bag attacher 170 to create user-defined angle 410 conducive for accessing golf clubs 128; and step three 603 accessing golf clubs 128 and golf related articles from golf bag 125. Support bracket 120 may be removed as desired.

It should be noted that the steps described in the method of use can be carried out in many different orders according to user preference. The use of “step of” should not be interpreted as “step for”, in the claims herein and is not intended to invoke the provisions of 35 U.S.C. §112, ¶6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A support attachment for retaining a golf bag to a rear portion of a golf vehicle comprising:
at least one bracket assembly comprising;
at least one bracket support;
at least one golf vehicle fastener; and
at least one golf bag attacher;
wherein said bracket support comprises a proximal end and a distal end;
wherein said proximal end of said bracket support comprises a first support arm and a second support arm;
wherein said first support arm and said second support arm of said bracket support extend outwardly at a 90 degree angle from said bracket support;
wherein said first support arm and said second support arm of said bracket support comprise substantially identical measurements and dimensions;
wherein said first support arm and said second support arm are parallel to each other;
wherein said distal end of said first support arm and said second support arm each comprise a round-shaped hole;
wherein said round-shaped hole(s) comprise a circumference substantially equivalent to a circumference of said at least one golf vehicle fastener, said golf vehicle fastener able to pass through said round-shaped hole(s);
wherein said rear portion of said golf vehicle fits within a gap space located between said first support arm and said second support arm of said bracket support;
wherein said at least golf vehicle fastener is insertable through said round-shaped hole of said first support arm to frictionally retain said rear portion of said golf vehicle against said second support arm;
wherein said at least one golf bag attacher is located on said distal end of said bracket support; and
wherein said golf bag is secured to said golf vehicle via said golf bag attacher attached to said bracket support during transport about a golf course while providing improved ease of access to said golf bag by a golfer.

2. The support attachment of claim 1, wherein said bracket support comprises ferrous material.

3. The support attachment of claim 1, wherein said bracket support comprises plastic.

4. The support attachment of claim 2, wherein said bracket support comprises a rust-proof coating providing enhanced weather-resistance of said support attachment.

5. The support attachment of claim 1, wherein said golf bag attacher attaches said golf bag to said bracket support forming a user-defined angle of said golf bag from said rear portion of said golf vehicle dependant on length of said golf bag attacher.

6. The support attachment of claim 5, wherein said user-defined angle enables said golfer to conveniently remove and insert at least one golf club from said golf bag, said golf club also oriented on said user-defined angle within said golf bag.

7. The support attachment of claim 1, wherein said golf bag attacher comprises a support ring.

8. The support attachment of claim 1, wherein said golf bag attacher comprises a sturdy-clip.

9. The support attachment of claim 8, wherein said sturdy-clip comprises a carabiner clip.

10. The support attachment of claim 6, wherein said bracket support is couplable with at least one existing securing strap of said golf bag belonging to said golfer.

11. The support attachment of claim 1, wherein said golf vehicle fastener comprises a thumb screw for securing said bracket support to said rear portion of said golf vehicle.

12. The support attachment of claim 1, wherein said golf vehicle fastener comprises a non-threaded fastener.

13. The support attachment of claim 12, wherein said non-threaded fastener comprises a pin and key fastener for securing said bracket support to said rear portion of said golf vehicle.

14. The support attachment of claim 12, wherein said non-threaded fastener comprises a recessed ball and a ring-pull, wherein said recessed ball is pushable in and out to release and lock said non-threaded fastener.

15. The support attachment of claim 10, wherein said bracket support provides a redundant securer of said golf bag in addition to an existing golf bag retaining belt on said golf vehicle.

16. The support attachment of claim 15, wherein said bracket support in combination with said existing golf bag retaining belt allow said golf bag to be positioned at a hang-sit angle of greater than 20 degrees relative to a vertical position of said rear portion of said golf vehicle, creating said user-defined angle.

17. The support attachment of claim 16, wherein a plurality of compartments in said golf bag are more accessible to said golfer via said user-defined angle provided by said bracket support.

18. The support attachment of claim 1, wherein said golf vehicle comprises a golf cart.

19. A support attachment for retaining a golf bag to a rear portion of a golf vehicle comprising:
at least one bracket assembly comprising:
a bracket support;
a vehicle fastener; and
a golf bag attacher comprising a carabiner clip;
wherein said bracket support comprises a proximal end and a distal end;
wherein said proximal end of said bracket support comprises a first support arm and a second support arm;
wherein said first support arm and said second support arm of said bracket support extend outwardly at a 90 degree angle from said bracket support;
wherein said first support arm and said second support arm of said bracket support comprise substantially identical measurements and dimensions;
wherein said first support arm and said second support arm are parallel to each other;
wherein said distal end of said first support arm and said second support arm each comprise a round-shaped hole;
wherein said bracket support comprises ferrous material;
wherein said bracket support comprises a rust-proof coating providing enhanced weather-resistance of said support attachment;
wherein said round-shaped hole(s) comprise a circumference substantially equivalent to a circumference of said golf vehicle fastener, said golf vehicle fastener able to pass through said round-shaped hole(s);
wherein said rear portion of said golf vehicle fits within a gap space, said gap space comprising a U-channel located between said first support arm and said second support arm of said bracket support;
wherein said golf vehicle fastener is insertable through said round-shaped hole of said first support arm to frictionally retain said rear portion of said golf vehicle against said second support arm;
wherein said golf bag attacher is located on said distal end of said bracket support;
wherein said golf bag attacher attaches said golf bag to said bracket support forming a user-defined angle of said golf bag from said rear portion of said golf vehicle dependant on length of said golf bag attacher; and
wherein said golf bag is secured to said golf vehicle via said golf bag attacher attached to said at least one bracket support during transport about a golf course while providing improved ease of access to said golf bag by a golfer.

20. A method of using a support attachment for retaining a golf bag to a golf vehicle comprising the steps of:
installing a support bracket to a rear portion of said golf vehicle via a golf vehicle fastener;
attaching said golf bag to said support bracket via a golf bag attacher to create a user-defined angle conducive for accessing golf clubs; and
accessing said golf clubs and golf related articles from said golf bag.
